(19) United States
(12) Patent Application Publication
(10) Pub. No.: US 2010/0061443 A1
(43) Pub. Date: Mar. 11, 2010

(54) METHOD AND SYSTEM FOR VIDEO STREAMING OF A GRAPHICAL DISPLAY OF AN APPLICATION

(76) Inventors: Eran MAMAN, Bat Hefer (IL); Lior ASULIN, Netanya (IL); Arie AIG, Haifa (IL)

Correspondence Address: Pearl Cohen Zedek Latzer, LLP, 1500 Broadway, 12th Floor, New York, NY, 10036, US

(21) Appl. No.: 12/556,104

(22) Filed: Sep. 9, 2009

Related U.S. Application Data
(60) Provisional application No. 61/095,711, filed on Sep. 10, 2008.

(51) Int. Cl. H04N 7/12

(52) U.S. Cl. 375/240.01; 375/E07.076

(57) ABSTRACT

A computer implemented method, computer system and computer executable program product are disclosed. The method includes running an application with a graphical output by a processor unit of a computer apparatus, analyzing the graphical output to detect and locate pixel changes in consecutive frames of the graphical output; and encoding video data of the graphical output, to a sequence of full frame and partial frame pictures, each of the full frame pictures including image data of an entire frame of the graphical display and each of the partial frame pictures including image data relating only to zones in a frame in which pixel changes where located.

### CROSS REFERENCE TO RELATED APPLICATIONS

This application claims priority of U.S. Provisional Patent Application 61/095,711, filed on Sep. 10, 2008 entitled Method and system for video streaming of a graphical display of an application, which is incorporated in its entirety herein by reference.

### BACKGROUND OF THE INVENTION

A Digital Video Recorder (DVR, sometimes referred to as “personal video recorder”, or PVR), which allows a viewer to record a broadcasted program onto a memory device in a set-top box (STB) and view it at a later time.

Network Personal Video Recorder (nPVR) was also introduced, which provides a network based PVR, where instead of the viewer recording his favorite program in a memory in his STB, a large storage room is provided in the network for a plurality of viewers to save and play their saved programs.

Other television based applications, such as, for example, time shift television (TV) and games were also introduced. The Internet is also making quick inroad into the video world and it is predicted that the Television and the Internet worlds will be merged at some point in the near future.

It is very relatively easy to introduce new applications on the Internet Small garage applications, such as Facebook™, can quickly grow to huge success. This is due to the flexibility of the Internet and low demand of resources required for the introduction of a new application. On the other hand, in the television world the situation is quite the opposite. The development cycle of a new application is very long and requires very extensive testing as the STB devices that run those applications are very sensitive and limited in resources such as memory and central processing unit (CPU) power. This leads to a situation where despite technological advancement the evolvement of television services is very slow.

Typically, applications in the Digital TV world run on a STB. The STB is a device that has a significantly lower processing powerful than a computer. Furthermore, a service provider (SP) in many cases has several generations of STBs available and therefore committed to the standards of the STB of the lowest common denominator. This means that STB applications are substantially more limited compared to applications in the Personal Computer (PC) world, both in their technology and in their look and feel In addition, in order to provide flawless operation over millions of STBs the SP has very strict security and quality assurance processes, further limiting development agility.

A method of streaming the application to the STB to overcome the above mentioned shortcomings was disclosed (see, for example, WO 2008/044916 A2) An application is running on a server; its screen captured, converted to a video stream (MPEG) and then streamed to the STB. This means that while the application is running on a server the user at home sees it as if it was run on his STB. In order to stream the application, the application is encoded to MPEG (or other video streaming format). The usual encoding process includes the encoder analyzing the graphical output and generating encoded MPEG data. The required resources are proportional to the area of the displayed screen of the application that the encoder has to analyze.

Compressed video stream generated by the encoder includes full frame (base) pictures (for example I-Frames in MPEG) and partial frame (delta) pictures (for example B and P frames in MPEG). In order to generate the delta pictures the encoder analyzes a current frame of the graphical output of the application and compares it to a previous frame.

Video streaming involves using compressed multimedia files. Typically the most important video codec standards in video streaming are H 261, H 263, MJPEG, MPEG1, MPEG2 and MPEG4 (the last three in particular are very popular).

In MPEG format a Video Elementary Stream (VES) is subjected to GOP (Group Of Pictures) encoding. To deal with temporal redundancy, MPEG divides the frames into groups, each referred to as a “group of pictures,” or GOP A VES is made up of I, P and B type pictures. An I (Intracoded) picture contains information of a whole new frame and is used as reference in the reconstruction of either P or B pictures, whereas a P (Predicted) picture contains information on several consecutive intermediate frames sharing information from the I picture. A P picture supports forward prediction from a previous picture. A B (Bi-directional) picture contains only information of a single intermediate frame.

When a plurality of clients are considered, it is noted that each client receives a personally encoded stream, which means that in order to provide service for a plurality of clients a server must generate a plurality of encoded streams. This encoding is a very intensive process and requires extensive server resources.

Typically a standard encoder employs complex algorithms which analyze each full frame of the input video, and which require substantial processing power (sometimes as much as 50-60 percent of the processing power of a processor, or even more), thus multiple stream encoding is practically impossible or very limited, rendering commercial application impractical. An encoder typically analyzes a frame in blocks (e.g. 16×16 pixels), each block distinctly identified, and compresses each block separately. If it is determines for a certain block that there are no pixel changes for that block (in consecutive frames), that block is not compressed when generating P or B pictures A corresponding decoder is made to figure out that if blocks are missing it means that no changes where present in these blocks and therefore image data may be used from previously streamed pictures in the reconstruction of the video output.

Furthermore, in many cases video data is presented to the encoder in a Bitmap format, whereas typical standard encoders work in the YUV domain, so that the encoder must also convert the video data from one format to another in the encoding process, thus using up more processing power.

Several methods where offered to deal with such a problem, most of them deal with preparing the content in advance in order to reduce the encoding process to a minimum (see, for example, WO 2008/044916 A2).

It is an object of the present invention to provide method and system for video streaming of a graphical display of a running application on a server to a remote display device, which deals efficiently with video streaming of a graphical output of an application and reduces usage of precious server resources. Other advantages and objects of the present invention will become apparent after reading the present specification and reviewing the accompanying figures.

### BRIEF DESCRIPTION OF THE INVENTION

There is thus provided, according to embodiments of the present invention, a computer implemented method. The method includes running an application with a graphical output by a processor unit of a computer apparatus, analyzing the graphical output to detect and locate pixel changes in consecutive frames of the graphical output; and encoding video data of the graphical output, to a sequence of full frame and partial frame pictures, each of the full frame pictures including image data of an entire frame of the graphical display and each of the partial frame pictures including image data relating only to zones in a frame in which pixel changes where located.

Furthermore, in accordance with some embodiments of the present invention, the method includes storing the graphical output in a virtual display memory in a memory unit.

Furthermore, in accordance with some embodiments of the present invention, the method includes using a display server application for performing the step of analyzing the graphical output to detect and locate pixel changes in consecutive frames of the graphical output.

Furthermore, in accordance with some embodiments of the present invention, the method is performed in a Linux environment.

Furthermore, in accordance with some embodiments of the present invention, the method includes presenting the image data to the encoder in An image format in which the encoder is designed to operate so as to render format conversion by the encoder redundant.

Furthermore, in accordance with some embodiments of the present invention, the format in which the image data is presented to the encoder is YUV.

Furthermore, in accordance with some embodiments of the present invention, there is disclosed a computer system. The computer system includes a memory unit to store an application which has a graphical display output when tun, to store a display server application to analyze the graphical output to detect and locate pixel changes in consecutive frames of the graphical output and to store an encoder to encode video data of the graphical output, to a sequence of full frame and partial frame pictures, each of the full frame pictures including image data of an entire frame of the graphical display and each of the partial frame pictures including image data relating only to zones in a frame in which pixel changes where located. The system also includes a processor unit for running the application, the display server application and the encoder.

Furthermore, in accordance with some embodiments of the present invention, there is disclosed a computer executable program product, which includes a computer readable media and a computer executable instructions stored on the computer readable media. The computer executable instructions include analyzing a graphical output of an application to detect and locate pixel changes in consecutive frames of the graphical output; and encoding video data of the graphical output, to a sequence of full frame and partial frame pictures, each of the full frame pictures including image data of an entire frame of the graphical display and each of the partial frame pictures including image data relating only to zones in a frame in which pixel changes where located.

Furthermore, in accordance with some embodiments of the present invention, the computer executable instructions include presenting the video data to the encoder in a format on which the encoder is designed to operate so as to render format conversion by the encoder redundant.

Furthermore, in accordance with some embodiments of the present invention, the format in which the image data is presented to the encoder is YUV.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a block diagram illustrating a method for video streaming of a graphical display of an application according to an embodiment of the present invention.

FIG. 2 is a block diagram illustrating a system 40 for video streaming of a graphical display of an application according to an embodiment of the present invention.

FIG. 3A and FIG. 3B illustrate two consecutive frames in a graphical output of an application with minor frame changes.

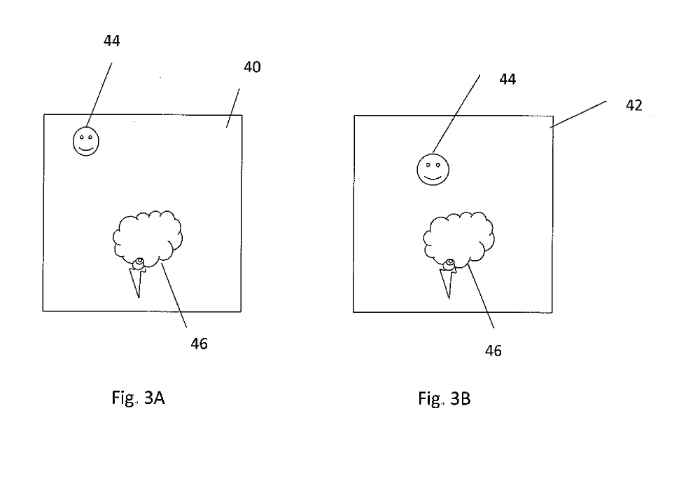

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operation herein. This apparatus may be specially constructed for the desired purposes, or it may comprise a general-purpose computer device selectively activated or reconfigured by a computer program (hereinafter also referred to as “application”) stored in the device. Such a computer program may be stored in a computer readable medium, such as, but not limited to, any type of disk, including floppy disks, optical disks, magnetic-optical disks, read-only memories (ROM's), compact disc read-only memories (CD-ROM's), random access memories (RAM's), electrically programmable read-only memories (EPROM's), electrically erasable and programmable read only memories (EEPROM's), FLASH memory, magnetic or optical cards, or any other type of media suitable for storing electronic instructions and capable of being coupled to a computer system bus.

Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of embodiments of the invention as described herein.

It should be appreciated that according to some embodiments of the present invention, the method described below, may be implemented in machine-executable instructions. These instructions may be used to cause a general-purpose or special-purpose processor that is programmed with the instructions to perform the operations described. Alternatively, the operations may be performed by specific hardware that may contain hardwired logic for performing the operations, or by any combination of programmed computer components and custom hardware components.

The method may be provided as a computer program product that may include a machine-readable medium having stored thereon instructions that may be used to program a computer (or other electronic devices) to perform the method. For the purposes of this specification, the terms “computer readable media” may include any medium that is capable of storing or encoding a sequence of instructions for execution by the computer and that cause the computer to perform any one of the methodologies of the present invention. The term “computer-readable media” may accordingly include, but not limited to, solid-state memories, optical and magnetic disks, and a carrier wave that encodes a data signal.

Although the scope of the present invention is not limited in this respect, the system and method disclosed herein may be implemented in many wireless, handheld and portable communication devices. By way of example, wireless, handheld and portable communication devices may include wireless and cellular telephones, smart telephones, personal digital assistants (PDAs), web-tablets and any device that may provide wireless access to a network such, an intranet or the internet. It should be understood that the present invention may be used in a variety of applications.

An aspect of the present invention is the provision of method and system for video streaming to a remote client of a graphic display of an application (a computer program) run on a computer apparatus, such as, for example, a server, which reduces usage of precious processing resources.

It is assumed that for many applications with a graphical display output, the majority of the graphical display includes static graphical objects which remain unchanged (when considering consecutive frames), while only a small percentage of frame area actually varies between consecutive frames.

Consider, for example, a typical Pacman game, in which only 3 to 5 percent of the graphical output screen is changed (that is the area covered by Pacman and other moving or otherwise dynamically-changing objects). The rest of the screen is static.

Reference is made to FIG. 4A and FIG. 4B illustrating two consecutive frames with minor frame changes Smiley 44 moves across the screen in consecutive frames 40 and 42, whereas most of the frame are includes static background and stationary object 46.

Embodiments of the present invention are hereby described which are implemented in a Linux environment with reference to video streaming in MPEG format, but it is understood that other embodiments implemented in other operating systems and other compressed video streaming formats are also covered by the scope of the present invention.

When an application is run in Linux, its graphical output is forwarded to a display server (X-server)—an algorithm process which performs some actions on the graphical output and then displays it on a display device.

Among the actions performed by the X-server include detection and recording of pixels changed in consecutive frames of the graphical output. For example, an open source VNC program may be used, which acts as an X server (in Unix-based systems) for the running application. The application sends requests via x-protocol to the VNC server. The VNC server is modified to supply the coordinates of the changes in the graphical output frames.

According to embodiments of the present invention the X-server code is modified so that instead of directing the graphical output to a display device the graphical output is stored in a shared memory (virtual display memory) which may be also accessed by an encoder.

An MPEG encoder, such as, for example FFMPEG or Intel Encoder, is modified so that instead of generating VES containing I, P and B pictures it generates only VES containing I and P pictures.

The encoder, instead of analyzing each consecutive frame to determine in which blocks pixel changes occurred, is modified to process only blocks in which pixel changes are present whose coordinates are provided by the VNC server.

In practice the P-frames encoding carried out by the adapted encoder may perform a loop on all macro blocks of a current frame and encode each macro block. A precondition for each macro block in the loop may be included in the adapted encoder requiring checking of the location of each of the macro blocks relative to the location of frame changes reported to the encoder. If the location of a particular macro block coincides with the location of one of the changes reported to the encoder then the macro block is encoded as usual by the encoder, otherwise encoding of other macro blocks is skipped.

This way a substantial processing power is saved.

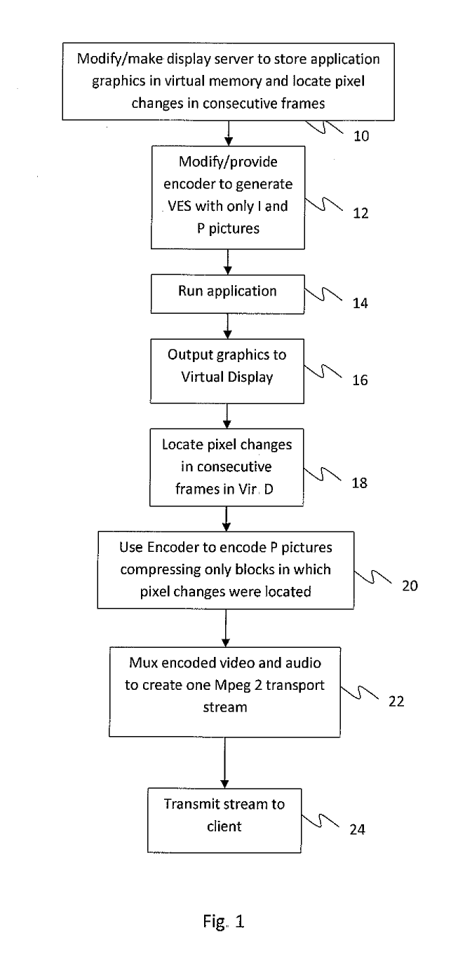

Reference is now made to FIG. 1, illustrating a block diagram illustrating a method for video streaming of a graphical display of an application according to an embodiment of the present invention.

Based in knowledge of Linux architecture, a display server application (e.g. VNC server) is modified so that the graphical output of an application run on the server is stored in a shared memory (virtual display memory), and pixel changes in consecutive frames are detected and located (10).

A video encoder (e.g. MPEG) is modified to generate VES with only I and P pictures. The P pictures are generated with image data relating just to image blocks in which pixel changes were located (12).

Then an Application is run (14) on the server. The graphical output of the application is stored in a virtual display memory (16) The display server detects and locates pixel changes in consecutive frames (18). The encoder is used to encode I and P pictures, where the P pictures only include compressed video data of image blocks in which pixel changes were located (20). Then the encoded video and audio (if audio exists) are muxed to create a vedieo stream, e.g. MPEG 2 (22) and the stream is transferred to the client (24).

Determining actual display changes in the run application or during rendering of the display at the server at an early stage and before the video encoder is used, renders the method and system according to embodiments of the present invention very efficient, since a simple algorithm is used to detect changes in consecutive frames in the graphical display output, instead of employing the encoder for the task of detecting frame changes. The encoder is only required (in P-pictures) to compress frame data that has been changed and not with entire frames.

Many standard encoders operate on one format (e.g. YUV), whereas image data is provided another format (e g Bitmap). In some embodiments of the present invention the image data presented to the encoder in provided in the same format which the encoder is designed to operate on thus rendering format conversion by the encoder redundant.

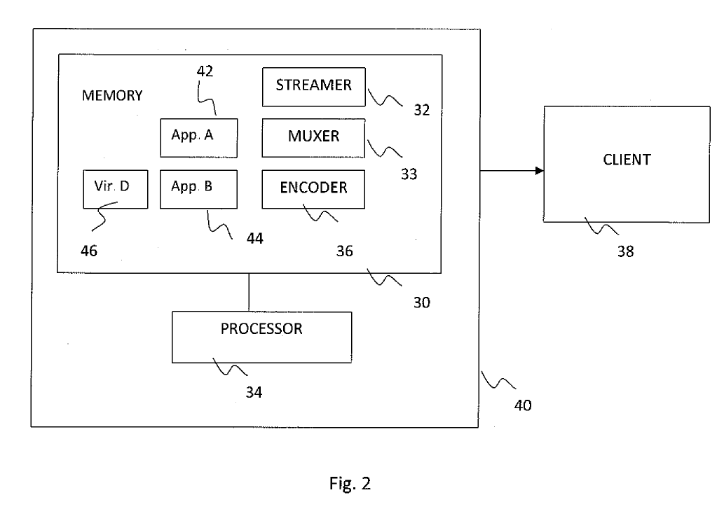

FIG. 2 is a block diagram illustrating a system 40 for video streaming of a graphical display of an application according to an embodiment of the present invention.

An application A 42, which is saved on memory unit 30 is run by processor 34, and the graphical display output of the application is presented as virtual display 46 and stored on memory 30 (may be the same or different memory unit) display server application B 44 (e.g. VNC server application), which may also be saved on memory 30 may run on the same processor 34 and is designed to analyze the virtual display so as to detect changes in the virtual display and to output coordinates of pixel changes in consecutive frames. The coordinates of the pixel changes are forwarded to encoder 36 (an application that may be stored in memory 30), which encodes the image data into a compressed video format (e.g. MPEG) with VES of I and P pictures. The compressed video data includes I pictures and P pictures which include data relating only to blocks in which pixel changes were detected. The compressed video stream is processed by muxer 33 and streamer 32 (applications that may be stored in memory 30) and streamed to remote client 38.

It is noted that some or all of the applications involved (e.g. application A, application B, encoder, streamer) may be stored on the same memory unit or on different memory units. It is also noted that some or all of these applications may be run on the same processor or on different processors.

In other embodiments of the present invention some or all of the applications may be implemented and embodied in the form of computer hardware for performing the operations of the applications.

It should be clear that the description of the embodiments and attached Figures set forth in this specification serves only for a better understanding of the invention, without limiting its scope.

It should also be clear that a person skilled in the art, after reading the present specification could make adjustments or amendments to the embodiments described herein that would still be included in the scope of the present invention.

What is claimed is:

1. A computer implemented method comprising the steps of:
running an application with a graphical output by a processor unit of a computer apparatus;
analyzing the graphical output to detect and locate pixel changes in consecutive frames of the graphical output; and
encoding video data of the graphical output, to a sequence of full frame and partial frame pictures, each of the full frame pictures including image data of an entire frame of the graphical display and each of the partial frame pictures including image data relating only to zones in a frame in which pixel changes where located.

2. A method as claimed in claim 1, comprising storing the graphical output in a virtual display memory in a memory unit.

3. A method as claimed in claim 2, comprising using a display server application for performing the step of analyzing the graphical output to detect and locate pixel changes in consecutive frames of the graphical output.

4. A method as claimed in claim 1, carried out in a Linux environment.

5. A method as claimed in claim 1, comprising presenting the image data to the encoder in An image format in which the encoder is designed to operate so as to render format conversion by the encoder redundant.

6. A method as claimed in claim 3, wherein the format in which the image data is presented to the encoder is YUV.

7. A computer system comprising:
a memory unit to store an application which has a graphical display output when run, to store a display server application to analyze the graphical output to detect and locate pixel changes in consecutive frames of the graphical output and to store an encoder to encode video data of the graphical output, to a sequence of full frame and partial frame pictures, each of the full frame pictures including image data of an entire frame of the graphical display and each of the partial frame pictures including image data relating only to zones in a frame in which pixel changes where located;
a processor unit for running the application, the display server application and the encoder.

8. A computer executable program product comprising: a computer readable media and a computer executable instructions stored on the computer readable media, the computer executable instructions including:
analyzing a graphical output of an application to detect and locate pixel changes in consecutive frames of the graphical output; and
encoding video data of the graphical output to a sequence of full frame and partial frame pictures, each of the full frame pictures including image data of an entire frame of the graphical display and each of the partial frame pictures including image data relating only to zones in a frame in which pixel changes where located.

9. A computer executable program product as claimed in claim 8, the computer executable instructions including presenting the video data to the encoder in a format on which the encoder is designed to operate so as to tender format conversion by the encoder redundant.

10. A computer executable program product as claimed in claim 9, wherein the format in which the image data is presented to the encoder is YUV.
